(19) United States
(12) Patent Application Publication
(10) Pub. No.: US 2019/0276254 A1
(43) Pub. Date: Sep. 12, 2019

(54) POSITIONING AND CONVEYING DEVICE

(71) Applicant: C.C.M. Beheer B.V., Nuenen (NL)

(72) Inventors: Ronald Plak, Waarland (NL); Gert van Ooik, Nuenen (NL)

(21) Appl. No.: 16/462,632

(22) PCT Filed: Nov. 20, 2017
(86) PCT No.: PCT/NL2017/050757

§ 371 Date: May 21, 2019

(30) Foreign Application Priority Data
Nov. 23, 2016 (NL) 2017854
Nov. 23, 2016 (NL) 2017855
Nov. 23, 2016 (NL) 2017856

(51) Int. Cl. B65H 5/02; B65H 7/02; B41J 11/00

(52) U.S. Cl. CPC B65H 5/021; B65H 7/02; B65H 2801/15; B65H 2404/254; B65H 2515/31; B41J 11/007

(57) ABSTRACT

A positioning and conveying device includes an endless conveyor belt which runs around two rollers mounted to a frame. The outer surface of the roller is defined by a plurality of roller segments which complementary cover the perimeter. The segments are individually movable in the axial direction for laterally moving the conveyor belt relative to the frame. The device includes at least one actuator assembly including a controllable magnetic actuator mounted at either end of the roller. At either end of the segments a ferromagnetic counterpart is mounted to cooperate with the respective magnetic actuators to move the respective segments in the axial direction. Each magnetic actuator comprises an electromagnet. Each ferromagnetic counterpart is arranged on a radial inner side of the associated segment. During rotation of the roller the roller segments and the associated counterparts follow a circular trajectory during a part of which they face the corresponding electromagnets.

### CROSS-REFERENCE TO RELATED APPLICATIONS

This application is the National Stage of International Application No. PCT/NL2017/050757, filed Nov. 20, 2017, which claims the benefit of Netherlands Application Nos. NL 2017855, filed Nov. 23, 2016, NL 2017854, filed Nov. 23, 2016, and NL 2017856, filed Nov. 23, 2016, the contents of all of which are incorporated by reference herein.

### FIELD OF THE INVENTION

The present invention relates to a positioning and conveying device comprising an endless conveyor belt which runs around two rollers mounted to a stationary frame.

### BACKGROUND OF THE INVENTION

Many positioning and/or conveying assemblies incorporate conveyor belts to transport material or work pieces and position it at a desired location. In those applications a belt is used in the form of a continuous loop which is supported at opposite reversing ends by rollers or the like. The belt might be used for transferring an object from one place to another and/or to position an object on a desired location, for example for processing, treating or machining the object. Proper operation of these systems may require that the belt moves in a controlled way with minimal positioning errors. For example, in inkjet printers each individual color plane is in general transferred to the substrate at different locations along the travel path of the conveyor belt or other substrate carrier. Therefore the position of the object (or substrate as it is called in printing technology) on the conveyor belt needs to be very stable and reproducible, for example within ±10 μmnsure that the resulting image is of good quality. Position errors of the conveyor belt may cause errors in the positioning of the object that is placed on the conveyor belt.

The present invention relates to a positioning and conveying device comprising an endless conveyor belt which runs around two rollers mounted to a stationary frame, such that the belt has an upper run forming a carrying side for objects to be positioned and transferred, and a lower run forming a return side of the belt. The outer surface of at least one of the rollers is defined by a plurality of roller segments extending in the axial and tangential direction of the roller, wherein each of the segments is axially dimensioned to support the full width of the conveyor belt and tangentially dimensioned such that the segments complementary cover the perimeter of the roller. The segments are individually movable in the axial direction of the roller for laterally moving the conveyor belt relative to the frame. The device furthermore includes at least one actuator assembly for driving the segments in the axial direction of the roller, said actuator assembly comprising a controllable magnetic actuator stationary mounted at either end of the roller. At either end of each of the segments a ferromagnetic counterpart is mounted which is configured and arranged to cooperate with the respective magnetic actuators so as to move the respective segments in the axial direction of the roller.

Such a positioning and conveying device is known from EP 2603445.

It is an object of the present invention is to improve the positioning accuracy of the positioning and conveying device.

### SUMMARY OF THE INVENTION

According to one aspect of the invention this object is achieved by a positioning and conveying device comprising an endless conveyor belt which runs around two rollers mounted to a stationary frame, such that the belt has an upper run forming a carrying side for objects to be positioned and transferred, and a lower run forming a return side of the belt. The outer surface of at least one of the rollers is defined by a plurality of roller segments extending in the axial and tangential direction of the roller, wherein each of the segments is axially dimensioned to support the full width of the conveyor belt and tangentially dimensioned such that the segments complementary cover the perimeter of the roller. The segments are individually movable in the axial direction of the roller for laterally moving the conveyor belt relative to the frame. The device furthermore includes at least one actuator assembly for driving the segments in the axial direction of the roller. The actuator assembly comprises a controllable magnetic actuator stationary mounted at either end of the roller, wherein at either end of each of the segments a ferromagnetic counterpart is mounted which is configured and arranged to cooperate with the respective magnetic actuators so as to move the respective segments in the axial direction of the roller. Each controllable magnetic actuator comprises an electromagnet including a core and a coil. Each ferromagnetic counterpart is arranged on a radial inner side of the associated roller segment and extends radially inwards and tangentially. During rotation of the roller the roller segments and the associated counterparts follow a circular trajectory during a part of which they face the corresponding electromagnets, wherein a variable axial air gap is present between the electromagnet and the ferromagnetic counterpart. Concentrically (radially inward) with the ferromagnetic counterpart a stationary ferromagnetic curved plate is arranged leaving a constant radial gap between the ferromagnetic counterpart and the ferromagnetic plate. The ferromagnetic curved plate is coupled to the core of the electromagnet such that a magnetic field created by the electromagnet runs through said ferromagnetic curved plate.

The axial position of the roller segment relative to the electromagnet varies during operation of the device. This varying axial position results in a varying distance between the electromagnet and the ferromagnetic counterparts passing by said electromagnet. This varying distance causes a variation in the actuator force as a function of the electrical current fed to the coil of the electromagnet. By adding the stationary ferromagnetic curved plate with the constant radial gap with respect to the counterpart, the variation in the actuator force as a function of the current is reduced. Thereby a more accurate force control can be achieved, which results in a more accurate positioning accuracy of the positioning and conveying device.

In a practical embodiment the device comprises an electronic controller connected to the electromagnets to control electric current through the coil of the electromagnets, and the device furthermore includes one or more gap distance sensors connected to the controller and provided near each of the electromagnets to measure the variable axial air gap between the electromagnet and the ferromagnetic counterpart.

In a preferred further embodiment the controller is configured such that it compensates for the variation in actuator force as a function of the current for varying positions of the roller segments.

In further embodiment the controller comprises a memory, wherein a look-up table is stored in the memory in which the actuator force as a function of the current for varying lateral positions of the segment is stored.

According to another aspect of the invention the mentioned object is achieved by a positioning and conveying device comprising an endless conveyor belt which runs around two rollers mounted to a stationary frame, such that the belt has an upper run forming a carrying side for objects to be positioned and transferred, and a lower run forming a return side of the belt. The outer surface of at least one of the rollers is defined by a plurality of roller segments extending in the axial and tangential direction of the roller, wherein each of the segments is axially dimensioned to support the full width of the conveyor belt and tangentially dimensioned such that the segments complementary cover the perimeter of the roller. The segments are individually movable in the axial direction of the roller for laterally moving the conveyor belt relative to the frame. The device furthermore includes at least one actuator assembly for driving the segments in the axial direction of the roller, said actuator assembly comprising a controllable magnetic actuator stationary mounted at either end of the roller, wherein at either end of each of the segments a ferromagnetic counterpart is mounted which is configured and arranged to cooperate with the respective magnetic actuators so as to move the respective segments in the axial direction of the roller. The roller has a stationary central shaft and a hub that is arranged concentrically rotatable around the central shaft, e.g. by means of bearings, and the roller segments are coupled to the hub by means of radial spacers comprising leaf springs allowing movement of the roller segments in the axial direction of the roller and biasing the roller segments to a neutral (central) axial position when out of the neutral axial position. The device includes a tensioning system for tensioning the belt in its longitudinal direction, the belt being pretensioned by the tensioning system, such that the axial force component on the roller segment resolved from the belt pretension force counterbalances the axial force on the roller segment due to stiffness of the leaf springs and a deviation of the roller segment from the neutral axial position.

According to this aspect of the invention the tensioning force results in a compression force on the leaf springs. The compression force on the leaf springs resolves in a force in the axial direction of the roller that is away from the neutral or central position of the segment. In the meantime an axial deviation from the neutral or central axial position of the segment causes in the leaf springs a deformation which in combination with the spring stiffness results in a spring force in the axial direction of the roller that wants the segment to move to the neutral axial position. The two forces thus work in opposite directions. The two forces vary both approximately linear with the axial position of the roller segment relative to the neutral position. Thus is achieved that in the axial working range of the segments the axial force component on the roller segment resolved from the belt pretension force counterbalances the axial force on the roller segment due to stiffness of the leaf springs when the roller segment is away from the neutral axial position. In the neutral position the compression force on the leaf springs does not resolve in an axial force component and the leaf springs are not flexed thus no spring force is induced. With this aspect of the invention a structure is achieved wherein no friction has to be overcome to move the segments, and wherein no counteracting spring force has to be overcome to move a roller segment. Therefore less control force is necessary to move the roller segments in the axial direction, whereby the controllability of the device is improved and thus the positioning accuracy of the device is improved.

According to yet another aspect of the invention the mentioned object is achieved by a positioning and conveying device comprising an endless conveyor belt which runs around two rollers mounted to a stationary frame, such that the belt has an upper run forming a carrying side for objects to be positioned and transferred, and a lower run forming a return side of the belt. The outer surface of at least one of the rollers is defined by a plurality of roller segments extending in the axial and tangential direction of the roller. Each of the segments is axially dimensioned to support the full width of the conveyor belt and tangentially dimensioned such that the segments complementary cover the perimeter of the roller. The segments are individually movable in the axial direction of the roller for laterally moving the conveyor belt relative to the frame. The device furthermore includes at least one actuator assembly for driving the segments in the axial direction of the roller, said actuator assembly comprising a controllable magnetic actuator stationary mounted at either end of the roller. At either end of each of the segments a ferromagnetic counterpart is mounted which is configured and arranged to cooperate with the respective magnetic actuators so as to move the respective segments in the axial direction of the roller. The device comprises at the roller a “set” actuator assembly and a “reset” actuator assembly. The “set” actuator assembly is arranged to work on the roller segments that are in contact with the belt to move the belt in the lateral direction. The “reset” actuator assembly is arranged to work on the roller segment(s) that is/are not in contact with the belt to reset the roller segment(s) to a neutral position.

The roller has a plurality of segments, in a practical embodiment it has three or more segments, such that during a full rotation the segment has a part of the circular trajectory in which it is not in contact with the conveyor belt running around the rollers. By controlling the axial position of the segments that are in contact with the belt, the lateral position of the belt can be controlled. This is done by the “set” actuator assembly. The segments that are not in contact with the belt must be repositioned (towards the neutral or central position). Repositioning in general is done often by means of a spring. However using springs (for example the leaf springs as mentioned above) to reposition the segments would result in vibrations that can cause positioning errors for the belt. Therefore according to this aspect of the invention repositioning is done by the “reset” actuator assembly which, like the “set” actuator assembly comprises a controllable magnetic actuator. The repositioning with controllable magnetic actuators as proposed allows repositioning of the segments in a controlled way such that disturbances on the belt caused by this repositioning are avoided or minimized. Thereby the positioning accuracy of the device is improved.

In a preferred embodiment each one of the magnetic actuators of the “set” actuator assembly and “reset” actuator assembly is able to submit a magnetic force on the passing segments in a circle sector which is defined by an angle α with respect to a centre plane of the conveyor belt extending in the middle between the upper run and the lower run, wherein the angle α≤±30° with respect to said centre plane. By this configuration the angle between the influence area of the “set” and “reset” actuator assemblies (≤120°) is larger than the angle of a roller segment (<120°), when the roller has at least three segments. Therefore the roller segment cannot be in front of magnetic actuators of both the “set” and “reset” actuator assemblies.

Consequently the “set” actuator assembly and the “reset” actuator assembly cannot apply a magnetic force on the same segment at the same time. Thereby the “set” and “reset” actuator assemblies do not influence each other and disturbances on the belt position, due to repositioning of the segment that is not in contact with the belt, are prevented.

In a preferred embodiment the device comprises an electronic controller connected to the controllable magnetic actuators to control the magnetic force generated by the magnetic actuators, and the device furthermore includes one or more gap distance sensors connected to the controller and provided near each of the magnetic actuators to measure the variable axial air gap between the magnetic actuator and the ferromagnetic counterpart. In a further embodiment the device has two air gap sensors near the “set” actuator assembly. In this embodiment two air gap sensors are thus positioned near the actuator assembly that controls the position of the segments that are in contact with the belt. When the gap measurement of one of these gap sensors is disturbed by a transition from one segment to the next segment a correct gap measurement can be done with the other gap sensor. The angular spacing between the two gap sensors is unequal to the angle between the roller segments (120°) to prevent that multiple gap sensors are disturbed at the same time by roller segment transitions.

In a further embodiment, an angle γ is defined between two virtual planes that respectively extend from the center of the roller through the respective air gap sensors positioned near the “set” actuator assembly, wherein the angle γ<120°. In this embodiment the angle γ between the two air gap sensors is thus smaller than the angle between the roller segments such that both air gap sensors measure the distance of the same segment before the measurement of the air gap sensor located downstream is disturbed by a segment transition.

In a further embodiment one air gap sensor is located near the “reset” actuator assembly. Preferably the air gap sensor that is positioned near the “reset” actuator assembly is positioned in a centre plane of the conveyor belt extending in the middle between the upper run and the lower run, whereby the gap measurement at the “reset” actuator assembly is not disturbed by segment transitions when the segment is free from the belt.

Preferably the “set” and “reset” actuator assemblies are similar.

It is noted that combinations of the mentioned aspects of the invention are also envisaged.

The invention also relates to a printing system comprising a printer station and a positioning and conveying device as described in the above for conveying and positioning a substrate at the printer station. In a practical embodiment the printer station comprises inkjet printing heads.

The invention will be elucidated further in the following description with reference to the drawings.

### BRIEF DESCRIPTION OF THE DRAWINGS

FIG. 1 shows schematically a side view of a positioning and conveying device according to the invention,

FIG. 2 shows in a view in perspective a roller of a preferred embodiment of the device of FIG. 1,

FIG. 3 shows a sectional view in perspective the roller of FIG. 2,

FIG. 4 shows in a cross section in perspective the roller of FIG. 2,

FIG. 5 shows schematically a longitudinal section of the roller of FIG. 2,

FIG. 6 shows schematically a cross section of the roller of FIG. 2 with a belt running around it,

FIG. 7 illustrates schematically a longitudinal section of the device according to the invention, and

FIG. 8 shows a detail of FIG. 7.

### DETAILED DESCRIPTION OF THE INVENTION

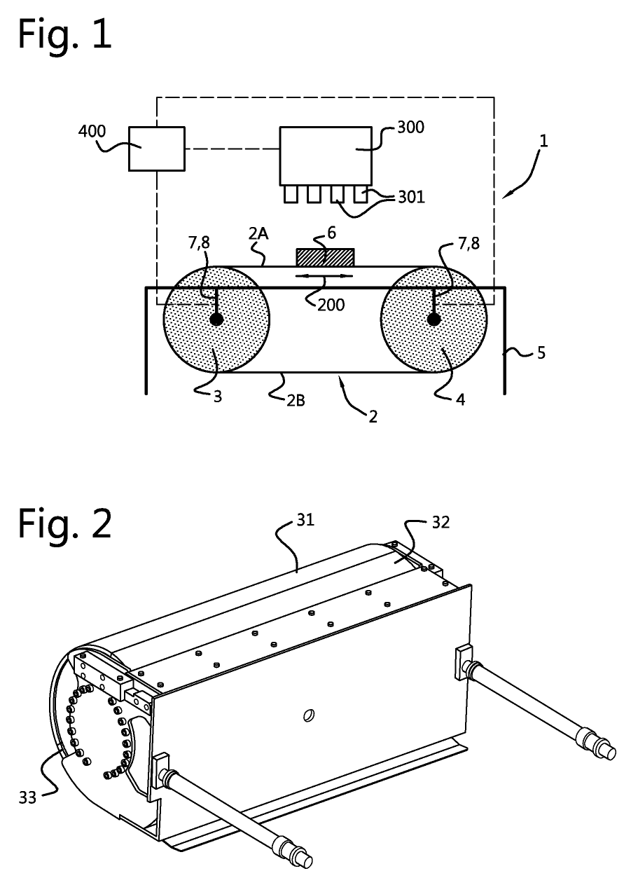

FIG. 1 shows schematically a positioning and conveying device 1. The device 1 comprises an endless conveyor belt 2 which runs around two rollers 3 and 4 respectively mounted to a stationary frame 5. The conveyor belt 2 has an upper run 2A forming a carrying side for objects 6 to be positioned and transferred, and a lower run 2B forming a return side of the belt 2. In FIG. 1 the conveying direction of the conveyor belt 2 is indicated by a double arrow 200.

The positioning and conveying device 1 is particularly suitable for for use with a printing system, wherein the objects 6 are substrates or webs that are conveyed along a path passing a printer station 300. The printer station 300 in particular comprises inkjet printing heads 301. In inkjet printers each individual color plane is in general transferred to the substrate at different locations along the travel path of the conveyor belt. Therefore the position of the object 6 (substrate or web) on the conveyor belt 2 needs to be very stable and reproducible, for example within ±10 μm, to ensure that the resulting image is of good quality.

It should be noted here that, besides printing applications, the positioning and conveying device 1 can also be used in combination with other article processing systems wherein a high positioning accuracy is needed. An example is for example a laser engraving system.

For positioning the objects 6 on the belt 2 a position control system is proposed which a.o. comprises a controller 400 that is able to control actuator assemblies 7, 8 in the rollers 3, 4 as will be described in the following.

In a preferred embodiment of the invention both rollers 3, 4 are the same. In the following the structure and working of the roller 3 will be elucidated with reference to FIGS. 2-6. It must be understood that this description is the same for the opposite roller 4.

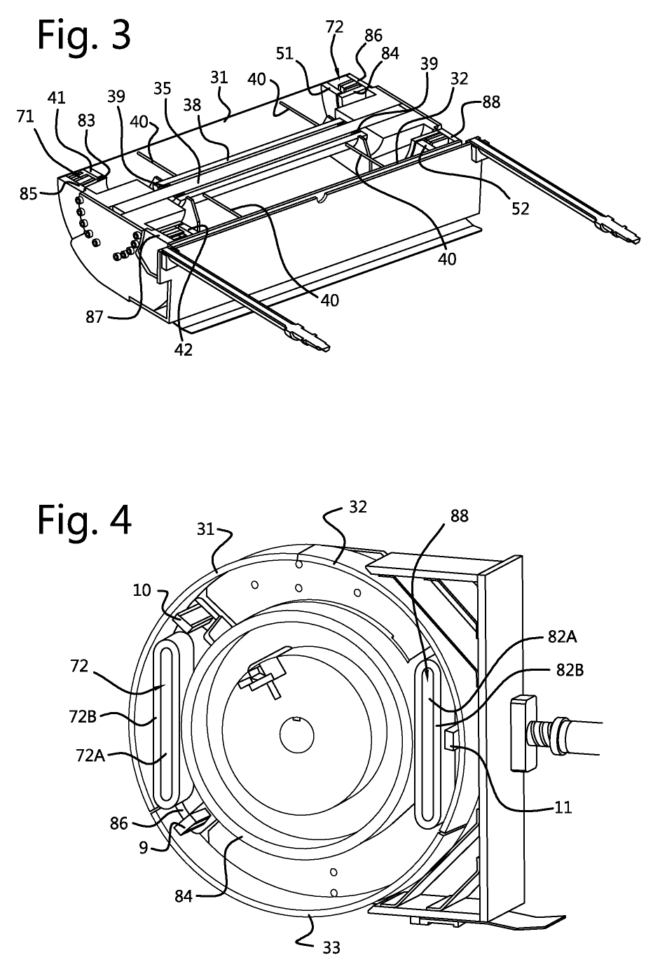

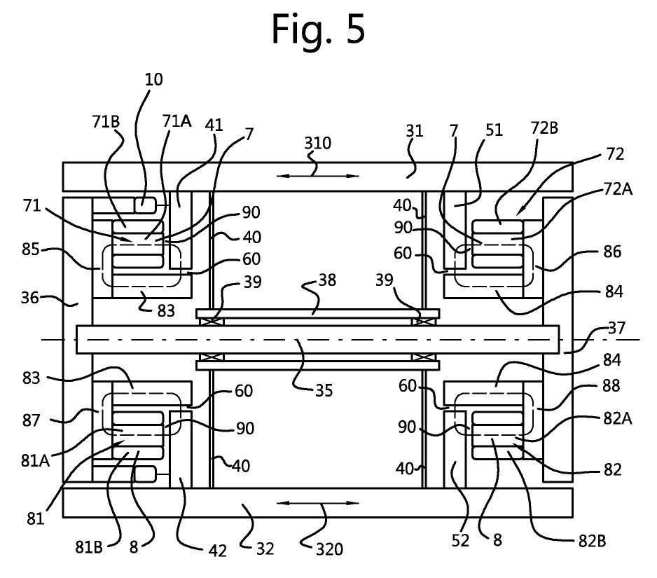

In FIGS. 2-6 the roller 3 is shown in more detail. The roller 3 has a stationary portion comprising a central spindle 35 and two side plates 36 and 37 respectively mounted to the respective ends of the spindle 35 (see FIGS. 3 and 5). The roller 3 also has a rotatable portion, which is rotatable around the central spindle 35. This rotatable portion includes a hub 38 formed as a cylindrical body that is mounted coaxially with the central spindle 35 and is supported rotatably relative to the spindle 35 by means of bearings 39, in this example ball bearings, mounted at either end of the cylindrical body of the hub 38.

The rotatable portion of the roller 3 furthermore comprises an outer jacket constituted by three roller segments 31, 32, 33. The outer surfaces of the segments 31, 32, 33 define the cylindrical outer surface of the roller 3. Each roller segment 31, 32, 33 is connected to the hub 38 by means of spacer elements 40. The spacer elements 40 function essentially as spokes in a wheel. As will be described below, the segments 31, 32, 33 are movable in the axial direction of the roller 3, thus in a transverse direction of the belt 2. The spacer elements 40 are designed as flexible elements such that they allow a movement of the segments 31, 32, 33 in the axial direction of the roller 3.

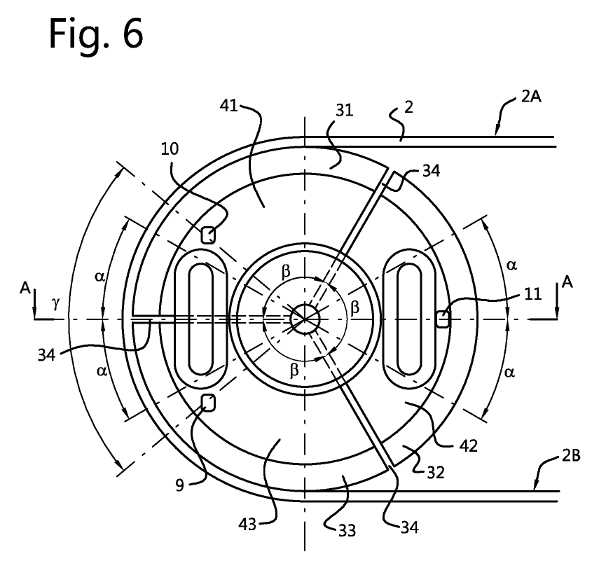

The roller segments 31, 32, 33 extend in the axial and tangential direction of the roller 3. Each of the roller segments 31, 32, 33 is axially dimensioned to support the full width of the conveyor belt 2 and tangentially dimensioned such that the three segments 31, 32, 33 complementary cover the perimeter of the roller 3 except for a number of (in this embodiment three) longitudinal transitional areas 34 between the segments 31, 32, 33. Each of the segments 31, 32, 33 in tangential direction of the roller 3 extends over an angle β≤120° (see FIG. 6).

The segments 31, 32, 33 are individually movable back and forth in the axial direction of the roller 3 as is indicated for the segments 31 and 32 in FIG. 5 by double arrows 310 and 320. The axial direction of the roller is perpendicular to the conveying direction 200 of the conveyor belt 2. By moving the segments 31, 32, 33 the friction between conveyor belt 2 and the roller segments 31, 32, 33 results in that the belt 2 is moved in its transverse direction relative to the stationary frame 5. Thereby an object 6 on the belt 2 can be positioned in the transverse direction and in the conveying direction.

The flexible spacer elements 40 guide the axial movement of the roller segments 31, 32, 33 without friction. To this end the flexible spacer elements 40 comprise leaf springs. The flexible spacer elements 40 are arranged such that if the segment 31, 32, 33 is moved laterally, seen in the longitudinal direction of the conveyor 1, out of a central position, the resiliency of the leaf springs 40 biases the segment 31, 32, 33 back to the central position in which the leaf springs 40 are not loaded.

For providing the actuating force to move the segments 31, 32, 33 controllable magnetic actuators are provided inside the end portions of the roller 3. In the preferred embodiment of the FIGS. 2-6, the roller 3 has two actuator assemblies 7 and 8 respectively. The first actuator assembly 7 is a “set” actuator assembly that is able to provide force to the segment(s) 31, 32, 33 on the outer side. For example in FIG. 4 mainly the segment 31 is in front of the “set” actuator assembly 7. For example in FIG. 6 the segments 31 and 33 are in front of the “set” actuator assembly 7. The second actuator assembly 8 is a “reset” actuator assembly that is able to provide force to the segment(s) 31, 32, 33 on the inner side. For example in FIG. 4 the segment 32 is in front of the “reset” actuator assembly 8. For example in FIG. 6 the segment 32 is in front of the “reset” actuator assembly 8.

The “set” actuator assembly is arranged to work on the roller segments that are in contact with the belt to move the belt 2 in the lateral direction; in the example of FIG. 6 these are the segments 31 and 33. The “reset” actuator assembly is arranged to work on the roller segment(s) that is/are not in contact with the belt 2 to reset the roller segment(s) to the central position also called neutral position; in the example of FIG. 6 this is the segment 32.

As can be best seen in FIGS. 3 and 5 the “set” actuator assembly 7 comprises two electromagnets 71 and 72 respectively, each located stationary inside an end portion of the roller 3. The electromagnets 71 and 72, respectively, are mounted to the side plates 36 and 37, respectively. The “reset” actuator 8 comprises electromagnets 81 and 82 respectively, each mounted stationary inside an end portion of the roller 3. The electromagnets 81 and 82, respectively, are mounted to the side plates 36 and 37, respectively.

The electromagnets 71, 72, 81, 82 comprise a core 71A, 72A, 81A, 82A of ferromagnetic material and a coil 71B, 72B, 81B, 82B wound around the corresponding core 71A, 72A, 81A, 82A. Radially inward from the electromagnets a stationary ferromagnetic cylindrical ring 83, 84 is arranged. The cylindrical ring 83, 84 is connected to one or more radial flanges 85, 86 mounted to the end plates 36, 37. The cylindrical ring 83, 84 extends beyond the electromagnet 71, 72, 81, 82 and radially inward from counterparts 41, 42, 43, 51, 52, 53, which will be described further below, leaving a constant radial gap 60 between the ferromagnetic counterparts 41, 42, 43, 51, 52, 53 and the ferromagnetic cylindrical ring 83, 84. The core 71A, 72A, 81A, 82A of each one of the electromagnets 71, 72, 81, 82 is positioned against the or one of the radial flanges 85, 86 of the cylindrical ring 83, 84 such that a magnetic field created by the electromagnet 71, 72, 81, 82 runs through said ferromagnetic cylindrical ring 83, 84. This is indicated in FIG. 5 by dashed lines.

The segments 31, 32 and 33, respectively, have counterparts 41, 42 and 43, respectively, mounted on the inner side of the segments near one end. Furthermore, the segments 31, 32 and 33, respectively, have counterparts 51, 52 and 53, respectively, mounted on the inner side of the segments near the other end. The counterparts 41, 42, 43 are configured and arranged to cooperate with the respective magnetic actuators 71, 72 so as to move the respective segments 31, 32, 33 in one axial direction of the roller 3. The counterparts 51, 52, 53 are configured and arranged to cooperate with the respective magnetic actuators 81, 82 so as to move the respective segments 31, 32, 33 in the opposite axial direction of the roller 3. The ferromagnetic counterparts 41, 42, 43, 51, 52, 53 are in the preferred embodiment formed as a circular ring sector that extends radially inwards from the roller segment 31, 32, 33 and extends over an arc of the inner surface of the corresponding ring segment 31, 32, 33. The circular ring sector may be made of ferromagnetic plate material, in particular steel plate material.

During rotation of the roller 3 the roller segments 31, 32, 33 and the associated ferromagnetic counterparts 41, 42, 43, 51, 52, 53 follow a circular trajectory during a part of which the counterparts 41, 42, 43, 51, 52, 53 face the corresponding electromagnets 71, 72, 81, 82. A variable axial air gap 90 is present between the electromagnet 71, 72, 81, 82 and the ferromagnetic counterpart 41, 42, 43, 51, 52, 53.

By feeding an electrical current to the coil 71B, 72B, 81B, 82B of the electromagnet 71, 72, 81, 82, a magentic field is generated, which attracts the ferromagnetic counterpart 41, 42, 43, 51, 52, 53. Thereby the ferromagnetic counterpart will move towards the actuated electromagnet and the associated segment will move accordingly.

The electrical current that is fed to the coil 71B, 72B, 81B, 82B of the electromagnets 71, 72, 81, 82 is controlled by the electronic controller 400 connected to the electromagnets 71, 72, 81, 82. The device 1 furthermore includes gap distance sensors 9, 10, 11 connected to the controller 400 and provided near part of the electromagnets to measure the variable axial air gap 90 between the electromagnet and the ferromagnetic counterpart.

In use the segments thus have a variable axial position. Consequently there is a varying distance between the electromagnets and the ferromagnetic counterparts passing by said electromagnets. If a electromagnet is actuated this varying distance causes a variation in the actuator force as a function of the electrical current fed to the coil of the electromagnet. By adding the stationary ferromagnetic curved plate with the constant radial gap 60 with respect to the counterpart, the variation in the actuator force as a function of the current is reduced. Thereby a more accurate force control can be achieved, which results in a more accurate positioning accuracy of the positioning and conveying device.

In the system 1 the gap distances are measured, which are representative for the lateral position of the belt 2. The controller 400, the electromagnets and the gap distance sensors form part of a position control loop.

The controller 400 is configured such that using the measurements by the gap distance sensors 9, 10, 11 it is able to compensate for the variation in actuator force as a function of the current for varying positions of the roller segments 31, 32, 33. In practise a calibration measurement is done to measure the variation of actuator force as a function of the actuator current for varying axial positions of the roller segments 31, 32, 33. This calibration measurement is stored as a look up table in a memory of the controller 400 and is used by the controller 400 to adapt the control signal (current) based on the measured gap distance

An angle γ can be defined between two virtual planes that respectively extend from the center of the roller through the respective air gap sensors 9 and 10 positioned near the “set” actuator assembly (see FIG. 6). The angle γ<120°. The angle γ between the two air gap sensors 9 and 10 is thus smaller than the angle between the roller segments such that both air gap sensors 9 and 10 measure the distance of the same segment 31, 32, 33 before the measurement of the air gap sensor 9 located downstream is disturbed by a segment transition 34 (see FIG. 6).

The air gap sensor 42 that is positioned near the “reset” actuator assembly is positioned in a centre plane, indicated by A-A in FIG. 6 of the conveyor belt 2, which centre plane A-A extends through the centre axis of the spindle 35 and in in the middle between the upper run 2A and the lower run 2B.

Each one of the magnetic actuators of the “set” actuator assembly and “reset” actuator assembly is able to submit a magnetic force on the passing countreparts 41, 42, 51, 52 of the segments 31, 32, 33 in a circle sector which is defined by an angle α with respect to a centre plane A-A of the conveyor belt 2, wherein the angle α≤±30° with respect to said centre plane A-A as is indicated in FIG. 6.

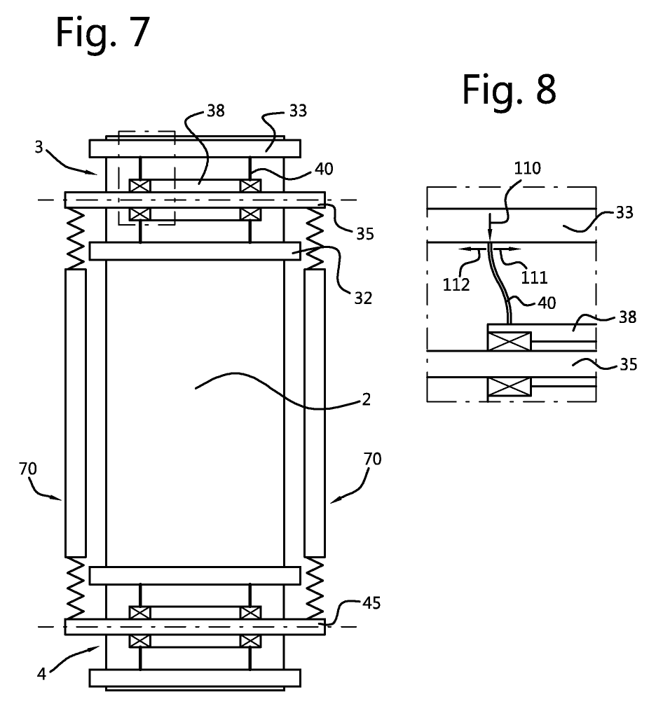

As is shown in FIG. 7 the device 1 includes a tensioning system 70 for tensioning the belt 2. The belt 2 is given a pretension by the tensioning system 70 by controlling the distance between the spindles 35 and 45 of the rollers 3 and 4. The pretension results in the belt 2 applying a compression force on the roller 3, 4, which will be described referring to roller 3. It must be understood that for the other roller 4 the same applies. The tensioning system 70 is preferably connected to the controller 400 that also controls the actuator assemblies 7, 8 of the rollers 3, 4.

The pretensioning force results in a compression force on the leaf springs 40 which is indicated in FIG. 8 by an arrow 110. The compression force 110 on the leaf springs 40 resolves in a force 112 in the axial direction of the roller 3 that is away from the neutral or central position of the segment. In the meantime an axial deviation from the neutral or central axial position of the segment causes in the leaf springs 40 a deformation which in combination with the spring stiffness results in a spring force 111 in the axial direction of the roller 3 that pushes the segment 31, 32, 33 towards the neutral axial position.

The two forces 111, 112 thus work in opposite directions. The two forces 111, 112 vary both approximately linear with the axial position of the roller segment 31, 32, 33 relative to the neutral position. Thus is achieved that in the axial working range of the segments 31, 32, 33 the axial force component 112 on the roller segment 31, 32, 33 resolved from the belt pretension force 110 counterbalances the axial force 111 on the roller segment 31, 32, 33 due to stiffness of the leaf springs 40 when the roller segment 31, 32, 33 is moved away from the neutral axial position.

In the neutral position the compression force 110 on the leaf springs 40 does not resolve in an axial force component and the leaf springs 40 are not flexed thus no spring force is induced. Advantageously the segments 31, 32, 33 can be moved without friction forces that have to be overcome. Moreover, by the described counterbalancing feature no counteracting spring force has to be overcome by the magnetic actuators to move a roller segments 31, 32, 33. Therefore less control force is necessary to move the roller segments 31, 32, 33 in the axial direction, whereby the controllability of the device 1 is improved and thus the positioning accuracy of the device 1 is improved.

The invention can be summarized by the following clauses:

1. Positioning and conveying device comprising an endless conveyor belt which runs around two rollers mounted to a stationary frame, such that the belt has an upper run forming a carrying side for objects to be positioned and transferred, and a lower run forming a return side of the belt,

wherein the outer surface of at least one of the rollers is defined by a plurality of roller segments extending in the axial and tangential direction of the roller, wherein each of the segments is axially dimensioned to support the full width of the conveyor belt and tangentially dimensioned such that the segments complementary cover the perimeter of the roller,
wherein the segments are individually movable in the axial direction of the roller for laterally moving the conveyor belt relative to the frame,
the device furthermore including at least one actuator assembly for driving the segments in the axial direction of the roller, said actuator assembly comprising a controllable magnetic actuator stationary mounted at either end of the roller,
wherein at either end of each of the segments a ferromagnetic counterpart is mounted which is configured and arranged to cooperate with the respective magnetic actuators so as to move the respective segments in the axial direction of the roller,
characterized in that
each controllable magnetic actuator comprises an electromagnet including a core and a coil, each ferromagnetic counterpart is arranged on a radial inner side of the associated roller segment and extends radially inwards and tangentially,
wherein during rotation of the roller the roller segments and the associated counterparts follow a circular trajectory during a part of which they face the corresponding electromagnets, wherein a variable axial air gap is present between the electromagnet and the ferromagnetic counterpart, and
wherein concentrically (radially inward) with the ferromagnetic counterpart a stationary ferromagnetic curved plate is arranged leaving a constant radial gap between the ferromagnetic counterpart and the ferromagnetic plate, said ferromagnetic curved plate being coupled to the core of the electromagnet such that a magnetic field created by the electromagnet runs through said ferromagnetic curved plate.

2. Positioning and conveying device according to clause 1, wherein the device comprises an electronic controller connected to the electromagnets to control electric current through the coil of the electromagnets, and the device furthermore includes one or more gap distance sensors connected to the controller and provided near each of the electromagnets to measure the variable axial air gap between the electromagnet and the ferromagnetic counterpart.

3. Positioning and conveying device according to clause 2, wherein the controller is configured such that it compensates for the variation in actuator force as a function of the current for varying positions of the roller segments.

4. Positioning and conveying device according to clause 2 or 3, wherein the controller comprises a memory, wherein a look-up table is stored in the memory in which the actuator force as a function of the current for varying lateral positions of the segment is stored.

5. Positioning and conveying device according to any one of the preceding clauses, wherein the device comprises at the roller a “set” actuator assembly and a “reset” actuator assembly, wherein the “set” actuator assembly is arranged to work on the roller segments that are in contact with the belt to move the belt in the lateral direction, and wherein the “reset” actuator assembly is arranged to work on the roller segment(s) that is/are not in contact with the belt to reset the roller segment(s) to a neutral position.

6. Positioning and conveying device according to clause 2 and 5, wherein the device has two air gap sensors near the set actuator assembly and one air gap sensor near the “reset” actuator assembly.

7. Positioning and conveying device according to clause 6, wherein an angle γ is defined between two virtual planes that respectively extend from the center of the roller through the respective air gap sensors positioned near the “set” actuator assembly, wherein the angle γ<120°.

8. Positioning and conveying device according to clause 6 or 7, wherein the air gap sensor that is positioned near the “reset” actuator assembly is positioned in a centre plane of the conveyor belt extending in the middle between the upper run and the lower run.

9. Positioning and conveying device according to any one of the clauses 5-8, each one of the magnetic actuators of the “set” actuator assembly and “reset” actuator assembly is able to submit a magnetic force on the passing segments in a circle sector which is defined by an angle α with respect to a centre plane of the conveyor belt extending in the middle between the upper run and the lower run, wherein the angle α≤±30° with respect to said centre plane.

10. Positioning and conveying device according to any one of the preceding clauses, wherein each roller has three or more roller segments.

11. Positioning and conveying device according to clause 10, wherein each of the segments in tangential direction of the roller extends over an angle β≤120°.

12. Positioning and conveying device according to any one of the preceding clauses, wherein the roller has a stationary central shaft and a hub that is concentrically rotatable around the central shaft, e.g. by means of bearings, and wherein the roller segments are coupled to the hub by means of radial spacers.

13. Positioning and conveying device according to clauses 12, wherein the radial spacers are leaf springs allowing movement of the roller segments in the axial direction of the roller and biasing the roller segments to a neutral (central) position when out of the neutral position.

14. Positioning and conveying device according to clause 13, wherein the device includes a tensioning system for tensioning the belt, the belt being pretensioned by the tensioning system, such that the axial force component on the roller segment resolved from the belt pretension force counterbalances the axial force on the roller segment due to stiffness of the leaf springs and a deviation of the roller segment from the neutral position.

15. Positioning and conveying device comprising an endless conveyor belt which runs around two rollers mounted to a stationary frame, such that the belt has an upper run forming a carrying side for objects to be positioned and transferred, and a lower run forming a return side of the belt,

wherein the outer surface of at least one of the rollers is defined by a plurality of roller segments extending in the axial and tangential direction of the roller, wherein each of the segments is axially dimensioned to support the full width of the conveyor belt and tangentially dimensioned such that the segments complementary cover the perimeter of the roller,
wherein the segments are individually movable in the axial direction of the roller for laterally moving the conveyor belt relative to the frame,
the device furthermore including at least one actuator assembly for driving the segments in the axial direction of the roller, said actuator assembly comprising a controllable magnetic actuator stationary mounted at either end of the roller,
wherein at either end of each of the segments a ferromagnetic counterpart is mounted which is configured and arranged to cooperate with the respective magnetic actuators so as to move the respective segments in the axial direction of the roller,
characterized in that
the roller has a stationary central shaft and a hub that is arranged concentrically rotatable around the central shaft, e.g. by means of bearings, and wherein the roller segments are coupled to the hub by means of radial spacers comprising leaf springs allowing movement of the roller segments in the axial direction of the roller and biasing the roller segments to a neutral (central) axial position when out of the neutral axial position, wherein the device includes a tensioning system for tensioning the belt in its longitudinal direction, the belt being pretensioned by the tensioning system, such that the axial force component on the roller segment resolved from the belt pretension force counterbalances the axial force on the roller segment due to stiffness of the leaf springs and a deviation of the roller segment from the neutral axial position.

16. Positioning and conveying device according to clause 15, wherein the device comprises at the roller a “set” actuator assembly and a “reset” actuator assembly, wherein the “set” actuator assembly is arranged to work on the roller segments that are in contact with the belt to move the belt in the lateral direction, and wherein the “reset” actuator assembly is arranged to work on the roller segment(s) that is/are not in contact with the belt to reset the roller segment(s) to a neutral position.

17. Positioning and conveying device comprising an endless conveyor belt which runs around two rollers mounted to a stationary frame, such that the belt has an upper run forming a carrying side for objects to be positioned and transferred, and a lower run forming a return side of the belt,

wherein the outer surface of at least one of the rollers is defined by a plurality of roller segments extending in the axial and tangential direction of the roller, wherein each of the segments is axially dimensioned to support the full width of the conveyor belt and tangentially dimensioned such that the segments complementary cover the perimeter of the roller,
wherein the segments are individually movable in the axial direction of the roller for laterally moving the conveyor belt relative to the frame,
the device furthermore including at least one actuator assembly for driving the segments in the axial direction of the roller, said actuator assembly comprising a controllable magnetic actuator stationary mounted at either end of the roller,
wherein at either end of each of the segments a ferromagnetic counterpart is mounted which is configured and arranged to cooperate with the respective magnetic actuators so as to move the respective segments in the axial direction of the roller,
characterized in that
the device comprises at the roller a “set” actuator assembly and a “reset” actuator assembly, wherein the “set” actuator assembly is arranged to work on the roller segments that are in contact with the belt to move the belt in the lateral direction, and wherein the “reset” actuator assembly is arranged to work on the roller segment(s) that is/are not in contact with the belt to reset the roller segment(s) to a neutral position.

18. Positioning and conveying device according to clause 17, wherein each one of the magnetic actuators of the “set” actuator assembly and “reset” actuator assembly is able to submit a magnetic force on the passing segments in a circle sector which is defined by an angle α with respect to a centre plane of the conveyor belt extending in the middle between the upper run and the lower run, wherein the angle α≤±30° with respect to said centre plane.

19. Positioning and conveying device according to clauses 17 or 18, furthermore comprising an electronic controller connected to the controllable magnetic actuators to control the magnetic force generated by the magnetic actuators, and the device furthermore includes one or more gap distance sensors connected to the controller and provided near each of the magnetic actuators to measure the variable axial air gap between the magnetic actuator and the ferromagnetic counterpart.

20. Positioning and conveying device according to clause 19, wherein the device has two air gap sensors near the “set” actuator assembly.

21. Positioning and conveying device according to clause 20, wherein an angle γ is defined between two virtual planes that respectively extend from the center of the roller through the respective air gap sensors positioned near the “set” actuator assembly, wherein the angle γ<120°.

22. Positioning and conveying device according to any one of clauses 17-21, wherein one air gap sensor is located near the “reset” actuator assembly.

23. Positioning and conveying device according to clause 22, wherein the air gap sensor that is positioned near the “reset” actuator assembly is positioned in a centre plane of the conveyor belt extending in the middle between the upper run and the lower run, whereby the gap measurement at the “reset” actuator assembly is not disturbed by segment transitions when the segment is free from the belt.

24. Positioning and conveying device according to any one of clauses 17-23, wherein the “set” and “reset” actuator assemblies are similar.

25. Printing system comprising a printer station and a positioning and conveying device according to any one of the preceding clauses, for conveying and positioning a substrate at the printer station.

1. A positioning and conveying device comprising an endless conveyor belt which runs around two rollers mounted to a stationary frame, such that the belt has an upper run forming a carrying side for objects to be positioned and transferred, and a lower run forming a return side of the belt,
wherein the outer surface of at least one of the rollers is defined by a plurality of roller segments extending in the axial and tangential direction of the roller, wherein each of the segments is axially dimensioned to support the full width of the conveyor belt and tangentially dimensioned such that the segments complementary cover the perimeter of the roller,
wherein the segments are individually movable in the axial direction of the roller for laterally moving the conveyor belt relative to the frame,
the device furthermore including at least one actuator assembly for driving the segments in the axial direction of the roller, said actuator assembly comprising a controllable magnetic actuator stationary mounted at either end of the roller,
wherein at either end of each of the segments a ferromagnetic counterpart is mounted which is configured and arranged to cooperate with the respective magnetic actuators so as to move the respective segments in the axial direction of the roller,
wherein each controllable magnetic actuator comprises an electromagnet including a core and a coil,
wherein each ferromagnetic counterpart is arranged on a radial inner side of the associated roller segment and extends radially inwards and tangentially,
wherein during rotation of the roller the roller segments and the associated counterparts follow a circular trajectory during a part of which they face the corresponding electromagnets, wherein a variable axial air gap is present between the electromagnet and the ferromagnetic counterpart, and
wherein concentrically radially inward with the ferromagnetic counterpart a stationary ferromagnetic curved plate is arranged leaving a constant radial gap between the ferromagnetic counterpart and the ferromagnetic plate, said ferromagnetic curved plate being coupled to the core of the electromagnet such that a magnetic field created by the electromagnet runs through said ferromagnetic curved plate.

2. The positioning and conveying device according to claim 1, wherein the device comprises an electronic controller connected to the electromagnets to control electric current through the coil of the electromagnets, and the device furthermore includes one or more gap distance sensors connected to the controller and provided near each of the electromagnets to measure the variable axial air gap between the electromagnet and the ferromagnetic counterpart.

3. The positioning and conveying device according to claim 2, wherein the controller is configured such that it compensates for the variation in actuator force as a function of the current for varying positions of the roller segments.

4. The positioning and conveying device according to claim 2, wherein the controller comprises a memory, wherein a look-up table is stored in the memory in which the actuator force as a function of the current for varying lateral positions of the segment is stored.

5. The positioning and conveying device according to claim 1, wherein the device comprises at the roller a “set” actuator assembly and a “reset” actuator assembly, wherein the “set” actuator assembly is arranged to work on the roller segments that are in contact with the belt to move the belt in the lateral direction, and wherein the “reset” actuator assembly is arranged to work on the roller segment(s) that is/are not in contact with the belt to reset the roller segment(s) to a neutral position.

6. The positioning and conveying device according to claim 2, wherein the device comprises at the roller a “set” actuator assembly and a “reset” actuator assembly, wherein the “set” actuator assembly is arranged to work on the roller segments that are in contact with the belt to move the belt in the lateral direction, and wherein the “reset” actuator assembly is arranged to work on the roller segment(s) that is/are not in contact with the belt to reset the roller segment(s) to a neutral position, and wherein the device has two air gap sensors near the set actuator assembly and one air gap sensor near the “reset” actuator assembly.

7. The positioning and conveying device according to claim 6, wherein an angle γ is defined between two virtual planes that respectively extend from the center of the roller through the respective air gap sensors positioned near the “set” actuator assembly, wherein the angle γ<120°.

8. The positioning and conveying device according to claim 6, wherein the air gap sensor that is positioned near the “reset” actuator assembly is positioned in a centre plane of the conveyor belt extending in the middle between the upper run and the lower run.

9. and conveying device according to claim 5, each one of the magnetic actuators of the “set” actuator assembly and “reset” actuator assembly is able to submit a magnetic force on the passing segments in a circle sector which is defined by an angle α with respect to a centre plane of the conveyor belt extending in the middle between the upper run and the lower run, wherein the angle α≤±30° with respect to said centre plane.

10. The positioning and conveying device according to claim 1, wherein each roller has three or more roller segments.

11. The positioning and conveying device according to claim 10, wherein each of the segments in tangential direction of the roller extends over an angle β≤120°.

12. The positioning and conveying device according to claim 1, wherein the roller has a stationary central shaft and a hub that is concentrically rotatable around the central shaft, e.g. by means of bearings, and wherein the roller segments are coupled to the hub by means of radial spacers.

13. The positioning and conveying device according to claim 12, wherein the radial spacers are leaf springs allowing movement of the roller segments in the axial direction of the roller and biasing the roller segments to a neutral (central) position when out of the neutral position.

14. The positioning and conveying device according to claim 13, wherein the device includes a tensioning system for tensioning the belt, the belt being pretensioned by the tensioning system, such that the axial force component on the roller segment resolved from the belt pretension force counterbalances the axial force on the roller segment due to stiffness of the leaf springs and a deviation of the roller segment from the neutral position.

15. A printing system comprising a printer station and a positioning and conveying device according to claim 1, for conveying and positioning a substrate at the printer station.

16. The positioning and conveying device according to claim 6, each one of the magnetic actuators of the “set” actuator assembly and “reset” actuator assembly is able to submit a magnetic force on the passing segments in a circle sector which is defined by an angle α with respect to a centre plane of the conveyor belt extending in the middle between the upper run and the lower run, wherein the angle α≤±30° with respect to said centre plane.
